(19) United States
(12) Patent Application Publication
(10) Pub. No.: US 2019/0071104 A1
(43) Pub. Date: Mar. 7, 2019

(54) CONTROL SOUNDNESS DETERMINATION DEVICE

(71) Applicant: KYB CORPORATION, Tokyo (JP)

(72) Inventor: Takayuki OGAWA, Tokyo (JP)

(73) Assignee: KYB CORPORATION, Tokyo (JP)

(21) Appl. No.: 16/083,586

(22) PCT Filed: Apr. 19, 2017
(86) PCT No.: PCT/JP2017/015736

§ 371 Date: Sep. 10, 2018

(30) Foreign Application Priority Data
Aug. 12, 2016 (JP) 2016-158560

(51) Int. Cl. B61F 5/24; F16F 15/02; G05B 23/02

(52) U.S. Cl. CPC B61F 5/245; G05B 23/02; F16F 15/02

(57) ABSTRACT

A control soundness determination device according to the present invention includes: a sensor which detects a control amount of a plant with respect to a control input input to the plant; and a determination unit which determines control soundness based on a soundness index obtained by multiplying the control input by a differential value of the control amount.

### TECHNICAL FIELD

The present invention relates to an improvement of a control soundness determination device.

### BACKGROUND ART

Conventionally, among control soundness determination devices, for example, a control soundness determination device which detects abnormality of a railway vehicle vibration damping device which suppresses a horizontal vibration of a vehicle body in a railway vehicle traveling direction is known.

More specifically, as disclosed in, for example, JP 11-222128 A, the control soundness determination device determines abnormality in a case in which a phenomenon that a control pressure command value to an actuator exceeds a pressure reference value and a vibration acceleration of the vehicle body exceeds an acceleration reference value is continued a predetermined number of times or a case in which an amplitude of the vibration acceleration continuously exceeds the reference value.

### SUMMARY OF THE INVENTION

When two values of the control pressure command value and the vibration acceleration are used, reference values are separately set. For this reason, when both values do not exceed the reference values, abnormality cannot be detected. Then, since the vibration acceleration is used, it takes time until abnormality is detected.

Further, if abnormality occurs when the amplitude of the vibration acceleration continuously exceeds the reference value, there is a possibility that abnormality may be erroneously detected due to noise or the like.

An object of the invention is to provide a control soundness determination device capable of more promptly and accurately determining control soundness.

A control soundness determination device according to the present invention includes: a sensor which detects a control amount of a plant with respect to a control input input to the plant; and a determination unit which determines control soundness based on a soundness index obtained by multiplying the control input by a differential value of the control amount.

### BRIEF DESCRIPTION OF DRAWINGS

FIG. 1 is a control block diagram of a control soundness determination device of an embodiment.

FIG. 2 is a schematic plan view of a railway vehicle equipped with a vibration damping device adopting the control soundness determination device of an embodiment.

FIG. 3 is a flowchart illustrating an example of a control soundness determination sequence of the control soundness determination device of an embodiment.

### DESCRIPTION OF EMBODIMENTS

Hereinafter, the invention will be described based on an embodiment illustrated in the drawings. In this example, a control soundness determination device 1 of an embodiment is configured to determine control soundness of a railway vehicle vibration damping device VC that suppresses a vibration of a vehicle body B by using the vehicle body B of the railway vehicle and an actuator A for damping the vehicle body B as a plant P.

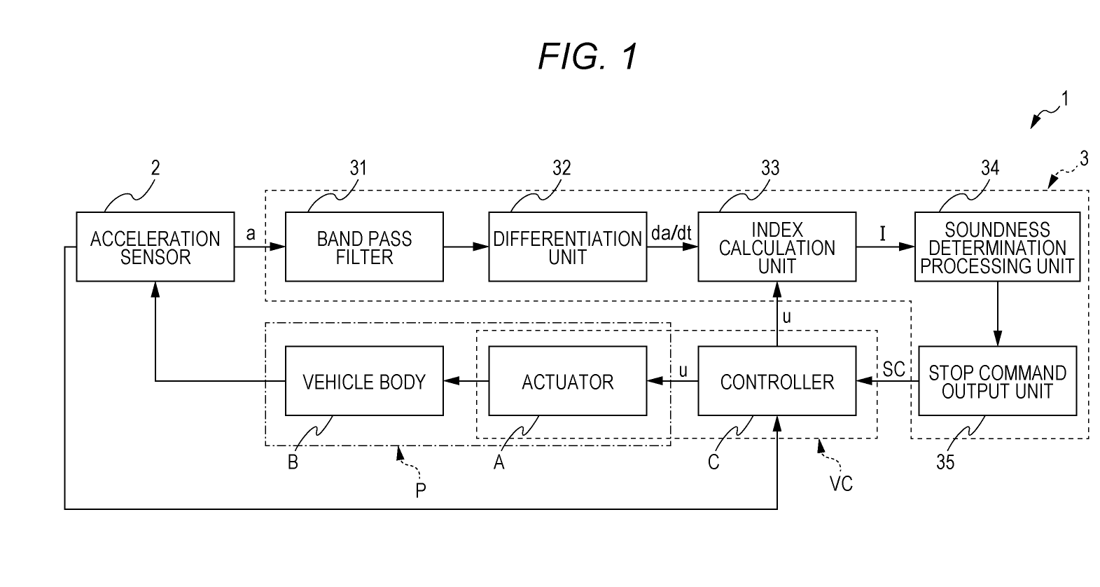

Specifically, the control soundness determination device 1 includes, as illustrated in FIG. 1, an acceleration sensor 2 which detects an acceleration a in the horizontal and lateral direction with respect to the vehicle traveling direction of the vehicle body B and a determination unit 3 which determines control soundness.

Hereinafter, components will be described in detail. In this example, the vibration damping device VC serves as a damping system which includes the actuator A and a controller C for controlling a thrust of the actuator A and suppresses a vibration of the vehicle body B by a control force exerted in the actuator A on the assumption that the vibration of the vehicle body B is a control target. Further, in this example, the plant P includes the vehicle body B of the railway vehicle and the actuator A and the actuator A exerts a thrust in response to a control input u input from the controller C so that the vibration of the vehicle body B is suppressed. In this case, the control amount of the plant P is set as the acceleration a of the vehicle body B.

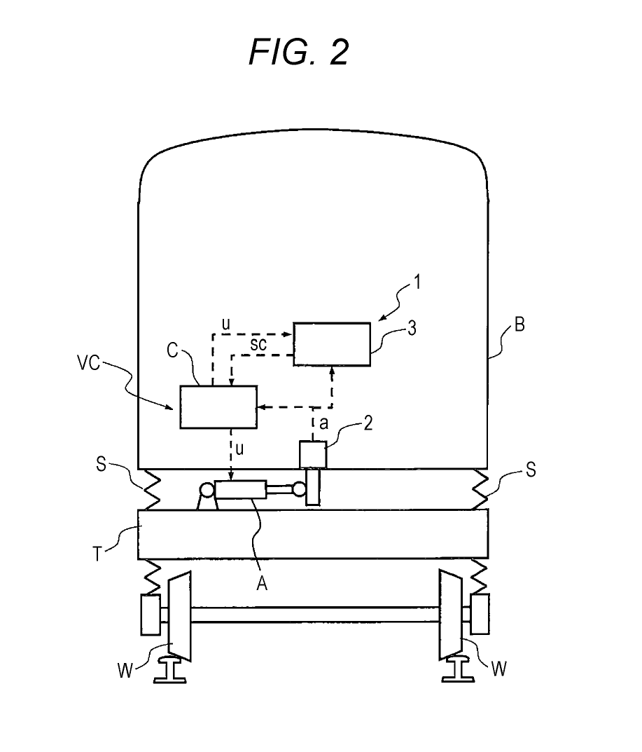

As illustrated in FIG. 2, the vehicle body B is elastically supported on a truck T holding vehicle wheels W traveling on a rail through the spring S and a relative movement in the up, down, left, and right directions in FIG. 2 with respect to the truck T is allowed. The acceleration sensor 2 is attached to the vehicle body B and detects the acceleration a of the vehicle body B. The acceleration a detected by the acceleration sensor 2 is used in the control soundness determination device 1 and is also input to the vibration damping device VC. Then, the vibration damping device VC inputs a control force decreasing the acceleration a to the actuator A as the control input u by using the control amount of the vehicle body B as the acceleration a.

Although not illustrated in the drawings, for example, the actuator A includes a cylinder which is connected to one of the truck T and the vehicle body B of the railway vehicle and expands and contracts by the supply of a fluid pressure, a pump which supplies a hydraulic fluid to the cylinder, a switching valve which switches an expansion and contraction direction of the cylinder, and a control valve which controls a pressure inside the cylinder. Then, the actuator A exerts a force according to the control input u by driving the control valve, the switching valve, and the pump in response to the control input u indicating the control force input from the controller C. Additionally, the control force which is the control input u indicates both the magnitude and the direction of the force exerted on the actuator A. Further, in this example, the actuator A exerts a damping force as a passive damper in a state in which the switching valve, the control valve, and the pump are not driven at all.

The controller C of the vibration damping device VC obtains the control force by removing noise, a drift component, or a normal acceleration in a curve included in the acceleration a and inputs the control force to the actuator A as the control input u. In this example, the controller C is configured as an H∞ controller and obtains the control force indicating the thrust to be output from the actuator A in order to suppress the vibration of the vehicle body B based on the acceleration a. For the control force, positive and negative signs are attached to the value indicating the magnitude of the force and the sign indicates the direction of the thrust to be output from the actuator A. Additionally, the controller C may obtain the control force by multiplying the acceleration a by a skyhook damping coefficient based on the skyhook control law.

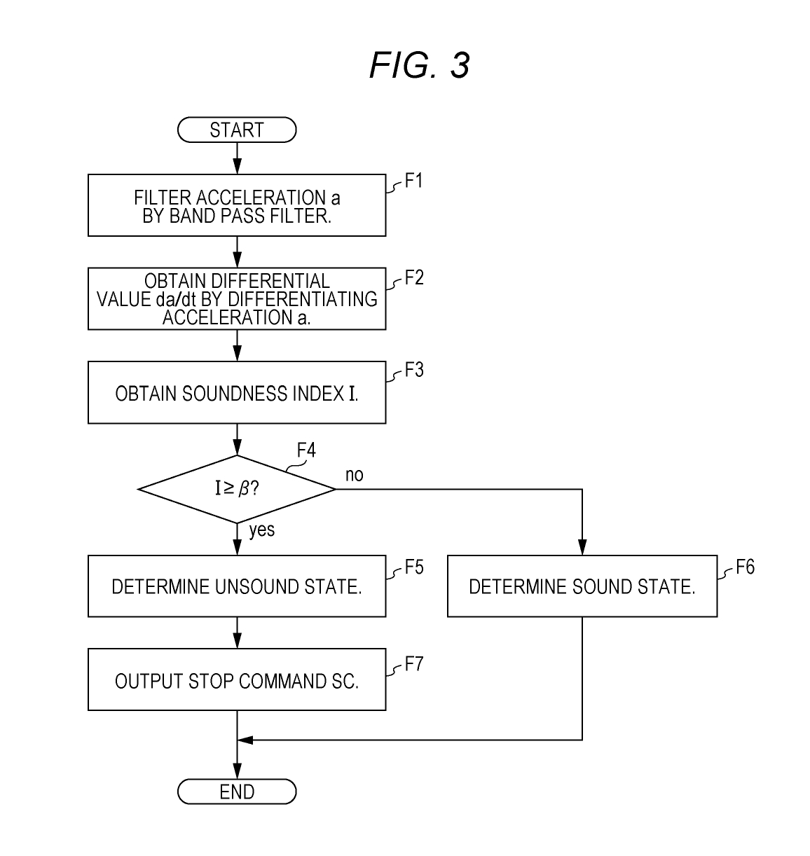

The determination unit 3 includes a band pass filter 31 which filters the acceleration a of the vehicle body B output from the acceleration sensor 2, a differentiation unit 32 which differentiates the acceleration a filtered by the band pass filter 31, an index calculation unit 33 which obtains a soundness index I from the control input u and a differential value da/dt of the acceleration a, a soundness determination processing unit 34 which determines soundness by comparing the soundness index I and the threshold value β to be described later, and a stop command output unit 35. Hereinafter, the operations of the components of the determination unit 3 will be described based on a flowchart that determines soundness as illustrated in FIG. 3.

The band pass filter 31 extracts a component of the resonance frequency band of the vehicle body B of the acceleration a by filtering the acceleration a and inputs the component to the differentiation unit 32 (step F1) In this example, the vibration damping device VC is used to suppress the vibration of the vehicle body B. Here, when the control soundness disappears, there is a great influence on the acceleration of the resonance frequency band of the vehicle body B. That is, the vibration damping device VC performs control of decreasing the acceleration of the vehicle body B. However, when controllability deteriorates and unsound control is performed, the acceleration cannot be decreased and the acceleration of the resonance frequency band of the vehicle body B in the plant P particularly increases. Thus, when the acceleration a is filtered by the band pass filter 31 through which only the resonance frequency band of the vehicle body B passes, the control soundness of the vibration damping device VC can be determined with high accuracy.

The differentiation unit 32 obtains the differential value da/dt of the acceleration a by differentiating the acceleration a processed by the band pass filter 31 (step F2). That is, the differentiation unit 32 obtains a jerk of the vehicle body B. The differentiation unit 32 may obtain the differential value da/dt by processing the acceleration a using a high pass filter or may obtain a difference between the input acceleration a and the precedent input acceleration a and may use the difference as the differential value da/dt for convenience.

The index calculation unit 33 obtains the soundness index I by multiplying the differential value da/dt obtained by the differentiation unit 32 by the control input u output from the controller C of the vibration damping device VC (step F3). Specifically, since the soundness index I is obtained by an absolute value process after multiplying the differential value da/dt by the control input u, the soundness index I is obtained by calculating I=|(da/dt)·u|.

The soundness determination processing unit 34 determines whether the soundness index I is equal to or larger than the threshold value β by comparing the soundness index I and the threshold value β (step F4). As a result, when the soundness index I is equal to or larger than the threshold value β, the soundness determination processing unit 34 determines that the control soundness is unsound (step F5). Further, the soundness determination processing unit 34 determines that the control soundness is sound when the soundness index I is smaller than the threshold value β (step F6). The threshold value β is a reference value for determining whether the vibration damping control of the vehicle body B of the vibration damping device VC is sound or unsound and is set to a value that the soundness index I takes when the actuator A vibrates the vehicle body B. Additionally, the threshold value β may be determined in consideration of the specification of the railway vehicle, the situation of the traveling railway, and the like.

Here, when the control is unsound and the vehicle body B is vibrated by the thrust exerted on the actuator A, the vibration of the vehicle body B is not suppressed and the acceleration a gradually increases. The vibration damping device VC exerts the control force on the actuator A so as to decrease the acceleration a, but when the acceleration a increases, the control force (the control input u) obtained by the controller C also increases. That is, when the control is unsound, the control input u of the acceleration a also gradually increases. The differential value da/dt indicates a future trend illustrating whether the acceleration a increases or decreases Thus, the soundness index I is an index which is set in consideration of whether the vibration of the vehicle body B is about to increase or decrease and becomes an index that can determine deterioration of controllability in advance. Further, since the soundness index I can be obtained by multiplying the control input u by the differential value da/dt, the soundness index I increases when the differential value da/dt increases even when the control input u is small. Accordingly, it is possible to accurately determine the deterioration of controllability also in such a state.

The stop command output unit 35 outputs a stop command SC of stopping control to the controller C of the vibration damping device VC when the soundness determination processing unit 34 determines that the control of the vibration damping device VC is unsound as a determination result of the control soundness (step F7). When the vibration damping device VC receives the stop command SC, control is stopped so that the supply of current to the actuator A is stopped. Then, the actuator A serves as a passive damper. In this way, since there is a possibility that the vibration of the vehicle body B may be amplified due to the vibration of the vehicle body B as the control is continued when it is determined that the control is unsound, the control of the vibration damping device VC is stopped and the actuator A is made to serve as a damper. Then, since the vibration of the vehicle body B is reduced by the damping force exerted by the actuator A, the vehicle body B can be stabilized while the vibration thereof is suppressed.

Additionally, as hardware resources, although not illustrated in the drawings, the determination unit 3 may specifically include, for example, an A/D converter which receives a signal output from the acceleration sensor 2, a storage device such as a read only memory (ROM) which stores a program used in a process necessary for determining the control soundness, a calculation device such as a central processing unit (CPU) which performs a process based on the program, and a storage device such as a random access memory (RAM) which provides a storage region to the CPU and the components of the determination unit 3 can be realized by the execution of the program of the CPU.

In this way, the control soundness determination device 1 includes the acceleration sensor 2 which detects the acceleration a as the control amount of the plant P with respect to the control input u input to the plant P and the determination unit 3 which determines the control soundness based on the soundness index I obtained by multiplying the control input u by the differential value da/dt of the acceleration a. The soundness index I is an index which is set in consideration of the differential value da/dt illustrating whether the vibration of the vehicle body B is about to increase or decrease and becomes an index that can determine deterioration of controllability in advance. Thus, in the control soundness determination device 1 that determines the control soundness based on the soundness index I, the deterioration of controllability can be predicted in advance and the control soundness can be determined at an early timing as compared with the conventional device. Further, since the soundness index I can be obtained by multiplying the control input u by the differential value da/dt, the soundness index I increases when the differential value da/dt increases even when the control input u is small. Accordingly, it is possible to accurately determine the deterioration of controllability. As described above, the control soundness determination device 1 of the invention can more promptly and accurately determine the control soundness. Furthermore, since it is possible to determine that the control is unsound even when the actuator A generates the control force in the opposite direction due to the erroneous wiring between the actuator A and the controller C, it is possible to detect the initial wiring error.

Further, the control soundness determination device 1 of this example can more accurately determine the control soundness since the determination unit 3 determines the control soundness by comparing the soundness index I and the threshold value β.

Furthermore, since the control soundness determination device 1 of this example includes the pass filter 31 which extracts the signal of the resonance frequency band of the plant P and processes the output of the acceleration sensor 2 by the band pass filter 31, the control soundness can be determined with high accuracy and the erroneous detection can be effectively prevented.

Then, in the control soundness determination device 1 of this example, the plant P includes the vehicle body B which is the vibration damping target and the actuator A which suppress the vibration of the vehicle body B by applying the control force to the vehicle body B and the sensor is the acceleration sensor 2 which detects the acceleration a of the vehicle body B. When the control soundness determination device 1 has such a configuration, the vibration damping device VC of the railway vehicle is suitable for determining the control soundness.

Additionally, the above-described determination unit 3 determines the control soundness just by comparing the soundness index I and the threshold value β, but may count the number of times that the soundness index I becomes equal to or larger than the threshold value β within a predetermined sampling time and determine that the control soundness is unsound when the count number becomes equal to or larger than the count threshold value γ. When the control soundness determination device 1 has such a configuration, it is not determined that the control soundness is unsound only by a state in which the controllability is instantly deteriorated due to disturbance. Thus, the control soundness determination device 1 with such a configuration can more accurately determine the control soundness Additionally, the sampling time can be arbitrarily set and may be set by the number of data items of the acceleration a since the sampling period of the acceleration a is determined. The count number of times that the soundness index I becomes equal to or larger than the threshold value β may be performed every sampling time. Alternatively, the number of times that the soundness index becomes equal to or larger than the threshold value β may be counted among the data obtained within a sampling time moving backward from the time of obtaining recent data whenever obtaining the data of the acceleration a.

Additionally, in this example, an example has been described in which the control soundness determination device 1 is used to determine the control soundness of the vibration damping device VC for suppressing the vibration of the vehicle body B of the railway vehicle, but the control soundness determination device 1 can be used to determine the control soundness of the control device other than the vibration damping device VC.

While the preferred embodiments of the invention have been described in detail, improvements, modifications, and changes can be made without departing from the scope of the claims.

This application claims priority based on Japanese Patent Application. No. 2016-158560 filed on Aug. 12, 2016 in Japan Patent Office, the entire contents of which are incorporated herein by reference.

1. A control soundness determination device comprising:
a sensor which detects a control amount of a plant with respect to a control input input to the plant; and
a determination unit which determines control soundness of a vibration damping device for suppressing a vibration of a control target based on a soundness index obtained by multiplying the control input by a differential value of the control amount,
wherein the control target and an actuator for suppressing the vibration of the control target are set as the plant.

2. The control soundness determination device according to claim 1,
wherein the determination unit determines the control soundness by comparing the soundness index and a threshold value.

3. The control soundness determination device according to claim 2,
wherein the determination unit counts the number of times that the soundness index becomes equal to or larger than the threshold value within a predetermined sampling time and determines that the control soundness is unsound when the count number becomes equal to or larger than a count threshold value.

4. The control soundness determination device according to claim 1, further comprising:
a band pass filter which extracts a signal of a resonance frequency band of the plant,
wherein an output of the sensor is processed by the band pass filter.

5. The control soundness determination device according to claim 1,
wherein the sensor is an acceleration sensor which detects an acceleration of the vibration damping target.
